(19) United States
(12) Patent Application Publication
(10) Pub. No.: US 2005/0119358 A1
(43) Pub. Date: Jun. 2, 2005

(54) Resin molding for optical base

(75) Inventors: Hiroaki Tatematsu, Ichihara-shi (JP); Kazuhiro Okuyama, Ichihara-shi (JP); Hiroshi Kawato, Ichihara-shi (JP); Satoru Kinouchi, Ichihara-shi (JP)

Correspondence Address: PARKHURST & WENDEL, L.L.P., 1421 PRINCE STREET, SUITE 210, ALEXANDRIA, VA, 22314-2805, US

(73) Assignee: Idemitsu Kosan Co., Ltd., Chiyoda-ku (JP)

(21) Appl. No.: 10/506,896

(22) PCT Filed: Mar. 7, 2003
(86) PCT No.: PCT/JP03/02710

(30) Foreign Application Priority Data
Mar. 8, 2002 (JP) 2002-63231

(51) Int. Cl. C08J 9/00

(52) U.S. Cl. 521/50

(57) ABSTRACT

A resin molding for use as optical base molded by means of micro-cellular foam molding, wherein the relative density of the resin molding is within a range of from 0.99 to 0.6. The ratio (f1/f2) of the linear expansion coefficient (f1) of the resin molding in MD direction at any given portion to the linear expansion coefficient (f2) of a non-foamed resin molding in MD direction at the same portion is preferably at least 1.05. The resin molding for use as optical base having the above-mentioned relative density and linear expansion coefficient has reduced dimensional change and deviation of optical axis during use of the same.

### FIELD OF THE ART

The present invention relates to a resin molding for use as an optical base, particularly to optical bases used for a liquid crystal display frame, optical box, DVD or CD pick-up, and the like.

### BACKGROUND OF THE ART

A resin molding for use as an optical base in a laser beam printer, facsimile device, optical pick-up, liquid crystal display frame, or the like is required to have high dimensional stability and stiffness. Such resin moldings have therefore been made of a composite of a thermoplastic resin and a fibrous filler, such as glass fibers or carbon fibers, blended in the thermoplastic resin.

However, when incorporating the fibrous filler, the anisotropy of the mold shrinkage factor becomes large and, therefore, it is necessary to incorporate a large amount of isotropic filler in order to decrease the deviation of the optical axis. Further, in order to sufficiently increase the strength and stiffness of the optical base, it is necessary to blend in a large amount of the fibrous filler.

As a result, the flowability of the resin composition decreases during injection molding, residual stress distortion arises and the dimensional change increases because of heat that is generated during the use of the optical base owing to the deviation of the optical axis. Further, there has been a problem that increase in the content of the fibrous filler causes a proportional increase in the anisotropy of linear expansion, which in turn produces anisotropy in the characteristics of the optical axis.

Furthermore, it is desirable to maintain or improve the damping properties by reducing the weight of the optical base while maintaining its specific rigidity. However, conventional chemical foaming can only achieve weight reduction and is incapable of maintaining the specific rigidity or increasing flowability, so that decrease of residual stress cannot be attained.

In view of the above-mentioned problems, the present invention aims to provide a resin molding for use as an optical base in which dimensional change and deviation of optical axis during the use of the resin molding are reduced.

The present inventors achieved this object based on the discovery that dimensional change and deviation of optical axis during the use of a resin molding can be reduced by adjusting the relative density of a specific resin composition to 0.99 to 0.6 by means of micro-cellular foam molding, and/or by making the ratio of linear expansion coefficient in the MD direction at any given portion of a molding prepared by using a supercritical fluid, relative to that at the same portion of a molding molded by another molding method, at least 1.05.

### DISCLOSURE OF THE INVENTION

The present invention provides a resin molding for use as an optical base molded by means of micro-cellular foam molding, wherein the relative density of said resin molding is within a range of from 0.99 to 0.6.

The ratio (f1/f2) of the linear expansion coefficient (f1) of the resin molding in MD direction at any given portion to the linear expansion coefficient (f2) of a non-foamed resin molding in MD direction at the same portion is preferably at least 1.05.

The resin molding is preferably made of a polycarbonate resin, a polyphenylene oxide/polystyrene alloy, a polyphenylene oxide/polystyrene/syndiotactic polystyrene alloy, syndiotactic polystyrene, polyphenylene sulfide, a syndiotactic polystyrene/polyphenylene sulfide alloy, polyphenylene sulfide and a polyphenylene oxide alloy, polyethylene terephthalate or polybutylene terephthalate.

The resin molding preferably contains a fibrous filler and/or an inorganic filler.

The resin molding preferably contains a melt tension modifier.

The molding is preferably an optical box for a laser beam printer, an optical box for a multifunctional printer, a laser scanner unit, an optical pickup base, an optical pickup lens holder, a chassis for an optical pickup, a chassis for an ink jet, a printer head, a panel frame for a flat display, a collimator holder for a laser beam printer or a liquid crystal projector lens holder.

### BEST MODE OF CARRYING OUT THE INVENTION

The present invention will be explained below in detail.

First, the constitutional components of the resin molding for use as an optical base of the present invention will be explained.

The resin constituting the resin molding for use as an optical base may be a resin used for producing ordinary moldings. These resins may be used alone or in mixtures of two or more.

As thermoplastic resins there can be preferably used a polycarbonate resin, syndiotactic polystyrene, polyphenylene sulfide, polyethylene terephthalate and polybutylene terephthalate.

More preferably used is an alloy of polyphenylene oxide/polystyrene, polyphenylene oxide/polystyrene/syndiotactic polystyrene, syndiotactic polystyrene/polyphenylene sulfide or polyphenylene sulfide/polyphenylene oxide.

For the purpose of reinforcing the resin molding, a fibrous filler may be added to the above-mentioned resin.

Specific examples of the fibrous filler include inorganic fibers such as glass fiber, silica glass fiber, alumina fiber, gypsum fiber, ceramic fiber and asbestos fiber; whiskers such as potassium titanate whisker and zinc oxide whisker; metal fibers such as aluminum and stainless steel; carbon fiber and the like. Preferred is glass fiber.

The above-mentioned fibrous fiber is added to the resin preferably in an amount of from 5 to 50% by weight and more preferably in an amount of from 10 to 50% by weight. When added in an amount of less than 5% by weight, the effect of increasing strength by the addition of the fibrous fiber is low, and when added in an amount exceeding 50% by weight, the anisotropy of the linear expansion coefficient becomes large, i.e., inappropriate.

An inorganic filler may also be added to the above-mentioned resin.

Specific examples of the inorganic fillers include talc, wallastonite, montmorillonite, kaolin, mica, sericite, clay, alumina silicate, glass beads, milled glass fiber, glass flake, calcium carbonate, silica, milled carbon fiber and the like. Preferred are mica, calcium carbonate, silica, talc, kaolin, glass flake and milled glass fiber.

The inorganic filler is added to the resin preferably in an amount of not more than 70% by weight and more preferably in an amount of not more than 65% by weight. When added in an amount exceeding 70% by weight, flowability of the resin during molding and strength of the resultant molding may decrease.

Also, for the purpose of modifying the melt tension of the thermoplastic resin and controlling the foam cell size and relative density of the foam, a melt tension modifier can be added. The melt tension modifiers include:

(1) Thermoplastic Resin Having Banched Chain Structure

A thermoplastic resin having a branched chain structure may be used as the thermoplastic resin, and such a thermoplastic resin having a branched chain structure may optionally be blended into an ordinary straight chain-type thermoplastic resin.

As a branching agent, it suffices to use one comprising the basic skeleton of the thermoplastic resin molecule or a skeleton similar thereto and having at least three functional reactive groups. For instance, when the thermoplastic resin is polystyrene, a branching agent such as trivinyl benzene may be used, and a polymer obtained by polymerization of styrene monomers including the branching agent in an amount of from about 0.1 to about 5% by weight may be used. When it is polycarbonate, 1,1,1-tris(4-hydroxyphenyl)ethane may suitably be used as the branching agent.

(2) High-Molecular Weight Acrylic Resin

Other than by use of the thermoplastic resin having a branched structure in the molecular structure, it is also possible to establish the melt tension at the same high level by addition of a high-molecular weight acrylic resin. The weight-average molecular weight of the high-molecular weight acrylic resin is preferably 300,000 or more, and more preferably 2,000,000 or more. P530A and P551A manufactured by Mitsubishi Rayon Co., Ltd. and the like may be employed.

(3) Polytetrafluoroethylene

Preferred are those capable of forming fibrils which increases melt tension.

(4) Composite Powder Containing Polytetrafluoroethylene

A3000 manufactured by Mitsubishi Rayon Co., Ltd. and the like may be used.

The components (1) to (4) may be used alone or as a mixture thereof.

The added amount of the melt tension modifier may optionally be selected based upon the above-mentioned thermoplastic resin type, the intended use and the properties required, and is preferably within a range of from 0.05 to 1% by weight, more preferably within a range of from 0.1 to 0.6% by weight. When added in an amount of less than 0.05% by weight, sufficient melt tension cannot be obtained so that foam shape cannot be controlled. When added in an amount exceeding 1% by weight, inhomogeneous foaming results, which is undesirable.

It is possible to add to the resin molding of the present invention, within a range of not impairing the effect of the present invention, a flame retardant-auxiliary agent (for example, antimony trioxide, sodium antimonate or the like), a nucleating agent (for example, sodium stearate, ethylene-sodium acrylate copolymer or the like), a stabilizer (for example, a phosphate ester, phosphite ester or the like), an antioxidant (for example, a hindered phenol compound or-the like), a light stabilizer, a coloring agent, a foaming agent, a lubricant, a mold-releasing agent, an antistatic agent and the like. Moreover, a small amount of rubber or the like may be added.

The relative density of the invention resin molding for use as an optical base composed of the foregoing constituents is within a range of from 0.99 to 0.6, preferably 0.95 to 0.7, more preferably from 0.92 to 0.75.

By relative density is meant the value given by dividing the density of the foamed resin molding by that of a non-foamed resin molding prepared by an ordinary molding method (injection molding or the like) without using a foaming agent.

The relative density can be controlled mainly by controlling the gas pressure used to prepare the supercritical fluid, and the amount of the resin charged into the metal mold.

When the relative density exceeds 0.99, no residual stress reducing effect is obtained, and when the relative density is less than 0.6, the size of foam cells in the molding increases so that the optical axis characteristics do not stabilize.

Further, the ratio (f1/f2) of the linear expansion coefficient (f1) in MD direction of the resin molding for use as an optical base at any given portion to the linear expansion coefficient (f2)in MD direction of the non-foamed resin molding-at the same portion is preferably 1.05 or more.

When the ratio of the linear expansion coefficients in MD direction is less than 1.05, dimensional change with heat becomes large, sometimes making the resin molding unsuitable for use as an optical base.

The linear expansion coefficient is closely related to the relative density so that it can be controlled by controlling the above-mentioned molding conditions.

Next, the method of producing the resin molding for use as an optical base of the present invention will be explained.

The resin composition prepared by mixing the above-mentioned resin, fibrous filler, inorganic filler and the like, or the composition prepared by melt-kneading these components and granulating or molding the mixture in advance, is put in a molding machine to make it into a micro-cellular foam.

Micro-cellular foam molding is a molding method that uses a supercritical fluid as the foaming agent.

A supercritical fluid is a fluid existing at a temperature exceeding the critical temperature under pressure exceeding the critical pressure. In the supercritical state, the density of a gas rapidly increases and the gas assumes a fluid state which cannot be distinguished between gas and liquid.

As termed with respect to the present invention, “supercritical liquid” is defined to include “subcritical fluid.”

Methods of producing a micro-cellular foam include a method of supplying a supercritical fluid or source gas to a molding machine to dissolve or impregnate it into a resin composition, and then, at a temperature at which the resin composition is plasticized, reducing the pressure in the system to expand the supercritical fluid and produce a foam.

The type of molding machine used is not particularly limited, and for instance, it is possible to use an injection molding machine, extrusion molding machine or the like.

In the case of injection molding, extrusion molding or the like, the supercritical fluid is supplied during melt-kneading of the resin composition.

The supercritical fluid is not particularly limited so long as it can dissolve into the above-mentioned resin composition and is inert, but carbon dioxide or nitrogen, or a mixture of these gases, is preferred in view of safety, cost and the like.

Methods available for impregnating the supercritical fluid into the resin composition include a method of injecting the supercritical fluid in a pressurized or reduced pressure state and a method of injecting an inert gas in a liquid sate by using a plunger pump or the like.

The pressure when the supercritical fluid is impregnated into the resin composition is required to be equal to or higher than the critical pressure of the supercritical fluid to be impregnated, and in order to increase the impregnating rate, it is required to be at least 15 MPa, preferably at least 20 MPa.

In the resin composition produced by the above-mentioned method, fine and uniform foam cells can be formed due to the excellent solubility and excellent diffusive property of the supercritical fluid. As a result, the residual stress at the time of molding can be reduced and, in addition, the anisotropy of the linear expansion coefficient is alleviated so that the dimensional change or the deviation of the optical axis at the time of using the resin molding decreases.

Owing to the foregoing reasons, the foamed resin molding of the present invention is suitable for optical base parts. Concretely, it can be used as an optical box for a laser beam printer, an optical box for a multifunctional printer, a laser scanner unit, an optical pickup base, an optical pickup lens holder, pickups and chassis for DVD and CD units, a chassis for an ink jet, a printer head, a panel frame for a flat display, a liquid crystal display frame, a collimator holder for a laser beam printer, a liquid crystal projector lens holder and the like. It is particularly suitable for use as a liquid crystal display frame, optical box, or pickup base for a DVD or CD unit.

### EXAMPLES

Examples of the present invention will be explained below but the present invention is by no means limited by these examples.

The resin moldings prepared in the respective examples were evaluated as follows:

(1) Relative Density

“Relative density” is defined as the value obtained by dividing the density of the foamed resin molding by the density of a molding produced by an ordinary molding method (non-foaming method). The density was measured in accordance with the method of ASTM D792.

(2) Warpage

The molding was fixed by a clamp and the height in the Z direction (vertical direction) was measured with a three-dimensional measuring machine. The greatest height from the base level (the clamp) was defined as the amount of warpage.

(3) Deviation Angle of Optical Axis

The molding was put in a clamp and a mirror was placed at the portion to be measured. A laser beam was shined vertically onto the surface of the mirror and the reflected light was detected with a non-contact angular measurement instrument to determine the angular deviation when the measurement temperature was raised from 40° C. up to 80° C.

(4) Linear Expansion Coefficient

Linear expansion coefficients of sample pieces cut from moldings (in the MD and TD directions) were measured in accordance with ASTM D696.

### Preparation Examples 1 to 20

Blended compositions each composed of a thermoplastic resin, a fibrous filler, an inorganic filler and a melt tension modifier, as shown in Table 1, were mixed and kneaded under the temperature conditions shown in Table 1 using a biaxial extruder, to prepare Preparation Example pellets.

As the thermoplastic resin, a polycarbonate resin was used in Preparation Examples 1 to 6, a polyphenylene sulfide resin was used in Preparation Examples 7 to 13, a polymer blend of polyphenylene sulfide and syndiotactic polystyrene was used in Preparation Example 14, and a polymer blend of polystyrene was used in Preparation Examples 15 to 20.

TABLE 1

| | | | | | | | | | | | | | | Pelletizing |
|---|---|---|---|---|---|---|---|---|---|---|---|---|---|---|
| | | | | | | | | | | | | | | Mixing and |
| | Composition (% by weight) | | | | | | | | | | | | | Kneading |
| Preparation | | Branched | | Branched | | | | | | Calcium | | | | temperature |
| Example | PC | PC | PPS | PPS | PPO | PS | SPS | GF | Mica | carbonate | Silica | F114 | PTFE | (° C.) |
| 1 | 90 | — | — | — | — | — | — | 10 | — | — | — | 0.1 | 0.3 | 280 |
| 2 | 70 | — | — | — | — | — | — | 30 | — | — | — | 0.1 | 0.3 | 280 |
| 3 | 50 | — | — | — | — | — | — | 50 | — | — | — | 0.1 | 0.3 | 280 |
| 4 | 70 | — | — | — | — | — | — | 15 | 15 | — | — | 0.1 | 0.3 | 280 |
| 5 | 50 | — | — | — | — | — | — | 20 | 30 | — | — | 0.1 | 0.3 | 280 |
| 6 | 50 | 20 | — | — | — | — | — | 15 | 15 | — | — | 0.1 | 0.3 | 280 |
| 7 | — | — | 90 | — | — | — | — | 10 | — | — | — | — | — | 340 |
| 8 | — | — | 50 | — | — | — | — | 50 | — | — | — | — | — | 340 |
| 9 | — | — | 30 | 20 | — | — | — | 50 | — | — | — | — | — | 340 |
| 10 | — | — | 30 | 20 | — | — | — | 20 | — | 10 | 20 | — | — | 340 |
| 11 | — | — | 50 | — | — | — | — | 10 | — | 20 | 20 | — | — | 340 |
| 12 | — | — | 20 | — | 10 | — | — | 30 | — | 40 | — | — | — | 340 |
| 13 | — | — | 20 | — | 10 | — | — | 15 | — | 55 | — | — | — | 340 |
| 14 | — | — | 10 | — | — | — | 20 | 20 | — | 50 | — | — | — | 300 |
| 15 | — | — | — | — | 15 | 75 | — | 10 | — | — | — | — | — | 300 |
| 16 | — | — | — | — | 10 | 40 | — | 50 | — | — | — | — | — | 300 |
| 17 | — | — | — | — | 15 | 35 | — | 20 | — | 20 | 10 | — | — | 300 |
| 18 | — | — | — | — | | 70 | 20 | 10 | — | — | — | — | — | 300 |
| 19 | — | — | — | — | 12 | 25 | 13 | 50 | — | — | — | — | — | 300 |
| 20 | — | — | — | — | 12 | 25 | 13 | 20 | — | 20 | 10 | — | — | 300 |

PC: Polycarbonate, manufactured by IDEMITSU PETROCHEMICAL CO., LTD., TAFLON FN1700A
Branched PC: Branched polycarbonate, manufactured by IDEMITSU PETROCHEMICAL CO., LTD., TAFLON FB2500A
PPS: Polyphenylene sulfide, manufactured by TOSOH CORPORATION, #160
Branched PPS: Branched polyphenylene sulfide, developed by IDEMITSU PETROCHEMICAL CO., LTD.
PPO: Polyphenylene oxide, manufactured by Mitsubishi Engineering-Plastics Corporation
PS: Polystyrene, manufactured by IDEMITSU PETROCHEMICAL CO., LTD., HT52
SPS: Syndiotactic polystyrene, manufactured by IDEMITSU PETROCHEMICAL CO., LTD., XAREC 130ZC
F114: Flame retardant, manufactured by DAINIPPON INK AND CHEMICALS INCORPORATED, MEGAFAC ™ F114
PTFE: Polytetrafluoroethylene, manufactured by Asahi Glass Fluoropolymers Co., Ltd., CD076
GF: Glass fiber, manufactured by ASAHI FIBER GLASS Co., JAFT591
Mica: manufactured by REPCO, M200
Silica: manufactured by DENKI KAGAKU KOGYO KABUSHIKI KAISHA, FB650

### Application Examples to Liquid Crystal Display Frame

### Examples 1 to 4

Using the pellets prepared in each of Preparation Examples 1, 7, 15 and 18, nitrogen gas (0.2 part by weight) was charged into the cylinder of an injection molding machine for micro-cellular foaming (manufactured by The Japan Steel Works, Ltd., 50 tons or 450 tons) under a pressure of 15 MPa, and micro-cellular foam molding was conducted under the conditions shown in Table 2 to produce liquid crystal display frame samples (size: 100 mm in length×165 mm in width×5 mm in height, wall thickness of from 0.5 to 1 mm).

### Comparative Examples 1 to 4

Samples were produced in the same manner as in Example 1 except that no nitrogen gas was supplied and a chemical foaming agent (manufactured by Eiwa Chemical Ind. Co., LTD., EB201) was used.

### Comparative Examples 5 to 8

Non-foamed samples were produced in the same manner as in Examples except that no nitrogen gas was supplied.

Molding conditions, relative densities and amounts of warpage of Examples 1 to 4 and Comparative Examples 1 to 8 are indicated in Table 2.

The results demonstrate that the resin molding of the present invention has much reduced amount of warpage in comparison with those of Comparative Examples.

TABLE 2

| | | | | | | | Chemically foamed | | | | | |
|---|---|---|---|---|---|---|---|---|---|---|---|---|
| Molding conditions | | | Micro-cellular molding | | | | material | | | Non-foamed material | | |
| | | Metal | | N₂ | | Amount | | | Amount | | | Amount |
| | Molding | mold | | injection | | of | | | of | | | of |
| Preparation | Temperature | temperature | | amount | Relative | warpage | | Relative | warpage | | Relative | warpage |
| Example | (° C.) | (° C.) | | (wt %) | density | (mm) | | density | (mm) | | density | (mm) |
| 1 | 320 | 110 | Ex. 1 | 0.2 | 0.9 | 0.1 | Comp. | 0.5 | 0.5 | Comp. | 1.0 | 1.0 |
| | | | | | | | Ex. 1 | | | Ex. 5 | | |
| 7 | 350 | 140 | Ex. 2 | 0.2 | 0.9 | 0.2 | Comp. | 0.5 | 0.6 | Comp. | 1.0 | 1.5 |
| | | | | | | | Ex. 2 | | | Ex. 6 | | |
| 15 | 280 | 80 | Ex. 3 | 0.2 | 0.9 | 0.1 | Comp. | 0.5 | 0.5 | Comp. | 1.0 | 1.2 |
| | | | | | | | Ex. 3 | | | Ex. 7 | | |
| 18 | 280 | 80 | Ex. 4 | 0.2 | 0.9 | 0.2 | Comp. | 0.5 | 0.5 | Comp. | 1.0 | 1.3 |
| | | | | | | | Ex. 4 | | | Ex. 8 | | |

### Application Examples to Optical Box

### Examples 5 to 13

Using the pellets prepared in each of Preparation Examples 2 to 6, 16, 17, 19 and 20, nitrogen gas (0.2% by weight) was charged into the cylinder of an injection molding machine for micro-cellular foaming under a pressure of 15 MPa, and micro-cellular foam molding was conducted under the conditions shown in Table 3 to produce samples of optical boxes (size: 217 mm in length×300 mm in width×45 mm in height, wall thickness of 2.5 mm).

### Comparative Examples 9 to 12

Samples were produced in the same manner as in Examples except that no nitrogen gas was supplied and the chemical foaming agent used in Comparative Example 1 was used.

### Comparative Examples 13 to 21

Non-foamed samples were produced in the same manner as in Examples except that no nitrogen gas was supplied.

The molding conditions, relative densities, optical axis angular deviations and linear expansion coefficients of Examples 5 to 13 and Comparative Examples 9 to 21 are indicated in Table 3.

With respect to the linear expansion coefficient, measurement was carried out on a test piece (3 mm×3 mm×2.5 mm in thickness) cut in the MD direction as viewed from the gate, from the vicinity of the portion of the optical box where the polygonal mirror was disposed.

By this, it was demonstrated that the resin molding of the present invention has much reduced the angular deviation of optical axis in comparison with those of Comparative Examples.

TABLE 3

| | | | Micro-cellular foamed material | | | | | Chemically foamd material | | | |
|---|---|---|---|---|---|---|---|---|---|---|---|
| Molding conditions | | | | | | Deviation | Linear | | | Deviation | Linear |
| | | Metal | | N₂ | | angle of | expansion | | | angle of | expansion |
| | Molding | mold | | injection | | optical | coefficient | | | optical | coefficient |
| Prep. | temp. | temp. | | amount | Relative | axis | (MD: | | Relative | axis | (MD: |
| Exam. | (° C.) | (° C.) | | (wt %) | density | (min.) | f1) × 10⁻⁵ | | density | (min.) | f3) × 10⁻⁵ |
| 2 | 320 | 110 | Ex. 5 | 0.2 | 0.9 | 5 | 2.63 | Comp | 0.5 | 8 | 2.55 |
| | | | | | | | | Ex. 9 | | | |
| 3 | 320 | 110 | Ex. 6 | 0.2 | 0.9 | 6 | 2.20 | Comp. | 0.5 | 9 | 2.00 |
| | | | | | | | | Ex. 10 | | | |
| 4 | 320 | 110 | Ex. 7 | 0.2 | 0.9 | 4 | 2.95 | — | — | — | — |
| 5 | 320 | 110 | Ex. 8 | 0.2 | 0.9 | 5 | 2.43 | — | — | — | — |
| 6 | 320 | 110 | Ex. 9 | 0.2 | 0.9 | 4 | 2.90 | — | — | — | — |
| 16 | 280 | 80 | Ex. 10 | 0.2 | 0.9 | 6 | 2.13 | Comp. | 0.5 | 9 | 1.92 |
| | | | | | | | | Ex. 11 | | | |
| 17 | 280 | 80 | Ex. 11 | 0.2 | 0.9 | 4 | 2.32 | — | — | — | — |
| 19 | 280 | 80 | Ex. 12 | 0.2 | 0.9 | 6 | 2.15 | Comp. | 0.5 | 9 | 1.93 |
| | | | | | | | | Ex. 12 | | | |
| 20 | 280 | 80 | Ex. 13 | 0.2 | 0.9 | 4 | 2.33 | — | — | — | — |

| | | | Non-foamed material | | | | | |
|---|---|---|---|---|---|---|---|---|
| Molding conditions | | | | | Deviation | Linear | Ratio of | |
| | | Metal | | | angle of | expansion | linear | |
| | Molding | mold | | | optical | coefficient | expansion | |
| Prep. | temp. | temp. | | Relative | axis | (MD: | coefficient | |
| Exam. | (° C.) | (° C.) | | density | (min.) | f2) × 10⁻⁵ | f1/f2 | f3/f2 |
| 2 | 320 | 110 | Comp | 1.0 | 10 | 2.50 | 1.05 | 1.02 |
| | | | Ex. 13 | | | | | |
| 3 | 320 | 110 | Comp | 1.0 | 12 | 1.95 | 1.13 | 1.03 |
| | | | Ex. 14 | | | | | |
| 4 | 320 | 110 | Comp | 1.0 | 8 | 2.75 | 1.07 | — |
| | | | Ex. 15 | | | | | |
| 5 | 320 | 110 | Comp | 1.0 | 9 | 2.30 | 1.06 | — |
| | | | Ex. 16 | | | | | |
| 6 | 320 | 110 | Comp | 1.0 | 8 | 2.74 | 1.06 | — |
| | | | Ex. 17 | | | | | |
| 16 | 280 | 80 | Comp | 1.0 | 12 | 1.91 | 1.12 | 1.01 |
| | | | Ex. 18 | | | | | |
| 17 | 280 | 80 | Comp | 1.0 | 8 | 2.22 | 1.05 | — |
| | | | Ex. 19 | | | | | |
| 19 | 280 | 80 | Comp | 1.0 | 12 | 1.90 | 1.13 | 1.02 |
| | | | Ex. 20 | | | | | |
| 20 | 280 | 80 | Comp | 1.0 | 8 | 2.21 | 1.05 | — |
| | | | Ex. 21 | | | | | |

### Application Examples to CD Pickup Base

### Examples 14 to 20

Using the pellets prepared in each of Preparation Examples 8 to 14, nitrogen gas (0.2 % by weight) was charged into the cylinder of an injection molding machine for micro-cellular foaming under a pressure of 15 MPa, and micro-cellular foam molding was conducted under the conditions shown in Table 4 to produce samples of CD pickup bases (size: 40 mm in length×15 mm in width×23 mm in height, wall thickness of from 1.5 to 3 mm).

### Comparative Examples 22 to 24

Samples were produced in the same manner as in Examples except that no nitrogen gas was supplied and the chemical foaming agent used in Comparative Example 1 was used.

### Comparative Examples 25 to 31

Non-foamed samples were produced in the same manner as in Examples except that no nitrogen gas was supplied.

The molding conditions, relative densities, optical axis angular deviations and linear expansion coefficients of Examples 14 to 20 and Comparative Examples 22 to 31 are indicated in Table 4.

With respect to the linear expansion coefficient, measurement was carried out on a test piece (3 mm ×3 mm ×5 mm in thickness) cut in the MD direction as viewed from the gate, which was selected from the portions having sufficient wall thickness able to be cut out and measured because of the complicated shape of the CD pickup base. When the wall thickness of the test piece was less than 3 mm, measurement was carried out using a clamp for maintaining the sample.

By this, it is demonstrated that the resin molding of the present invention has much reduced angular deviation of optical axis in comparison with those of Comparative Examples.

TABLE 4

| | | | Micro-cellular foamed material | | | | | Chemically foamed material | | | |
|---|---|---|---|---|---|---|---|---|---|---|---|
| Molding conditions | | | | | | Deviation | Linear | | | Deviation | Linear |
| | | Metal | | N₂ | | angle of | expansion | | | angle of | expansion |
| | Molding | mold | | injection | | optical | coefficient | | | optical | coefficient |
| Prep. | temp. | temp. | | amount | Relative | axis | (MD: | | Relative | axis | (MD: |
| Exam. | (° C.) | (° C.) | | (wt %) | density | (min.) | f1) × 10⁻⁵ | | density | (min.) | f3) × 10⁻⁵ |
| 8 | 350 | 140 | Ex. 14 | 0.2 | 0.9 | 2.8 | 1.90 | Comp | 0.5 | 4.50 | 1.73 |
| | | | | | | | | Ex. 22 | | | |
| 9 | 350 | 140 | Ex. 15 | 0.2 | 0.9 | 2.8 | 1.83 | Comp. | 0.5 | 4.30 | 1.74 |
| | | | | | | | | Ex. 23 | | | |
| 10 | 350 | 140 | Ex. 16 | 0.2 | 0.9 | 1.5 | 1.98 | Comp. | 0.9 | 3.0 | 1.90 |
| | | | | | | | | Ex. 24 | | | |
| 11 | 350 | 140 | Ex. 17 | 0.2 | 0.9 | 1.00 | 2.00 | — | — | — | — |
| 12 | 350 | 140 | Ex. 18 | 0.2 | 0.9 | 1.2 | 1.74 | — | — | — | — |
| 13 | 350 | 140 | Ex. 19 | 0.2 | 0.9 | 1.2 | 1.65 | — | — | — | — |
| 14 | 280 | 80 | Ex. 20 | 0.2 | 0.9 | 1.5 | 1.69 | — | — | — | — |

| | | | Non-foamed material | | | | | |
|---|---|---|---|---|---|---|---|---|
| Molding conditions | | | | | Deviation | Linear | Ratio of | |
| | | Metal | | | angle of | expansion | linear | |
| | Molding | mold | | | optical | coefficient | expansion | |
| Prep. | temp. | temp. | | Relative | axis | (MD: | coefficient | |
| Exam. | (° C.) | (° C.) | | density | (min.) | f2) × 10⁻⁵ | f1/f2 | f3/f2 |
| 8 | 350 | 140 | Comp | 1.0 | 8.0 | 1.70 | 1.12 | 1.02 |
| | | | Ex. 25 | | | | | |
| 9 | 350 | 140 | Comp | 1.0 | 8.0 | 1.72 | 1.06 | 1.01 |
| | | | Ex. 26 | | | | | |
| 10 | 350 | 140 | Comp | 1.0 | 5.0 | 1.88 | 1.05 | 1.01 |
| | | | Ex. 27 | | | | | |
| 11 | 350 | 140 | Comp | 1.0 | 2.5 | 1.90 | 1.05 | — |
| | | | Ex. 28 | | | | | |
| 12 | 350 | 140 | Comp | 1.0 | 2.9 | 1.64 | 1.06 | — |
| | | | Ex. 29 | | | | | |
| 13 | 350 | 140 | Comp | 1.0 | 2.7 | 1.57 | 1.05 | — |
| | | | Ex. 30 | | | | | |
| 14 | 280 | 80 | Comp | 1.0 | 3.5 | 1.60 | 1.06 | — |
| | | | Ex. 31 | | | | | |

Industrial Applicability

The present invention can provide a resin molding for use as an optical base which has reduced dimensional change and deviation of optical axis during the use of the same.

1. A resin molding for use as optical base molded by means of micro-cellular foam molding, wherein the relative density of said resin molding is within a range of from 0.99 to 0.6.

2. The resin molding for use as optical base according to claim 1, wherein the ratio (f1/f2) of the linear expansion coefficient (f1) of the resin molding in MD direction at any given portion to the linear expansion coefficient (f2) of a non-foamed resin molding in MD direction at the same portion is preferably at least 1.05.

3. The resin molding for use as optical base according to claim 1, wherein the resin molding is made of a polycarbonate resin, a polyphenylene oxide/polystyrene alloy, a polyphenylene oxide/polystyrene/syndiotactic polystyrene alloy, syndiotactic polystyrene, polyphenylene sulfide, a syndiotactic polystyrene/polyphenylene sulfide alloy, a polyphenylene sulfide and polyphenylene oxide alloy, polyethylene terephthalate or polybutylene terephthalate.

4. The resin molding for use as optical base according to claim 1, wherein the resin molding contains a fibrous filler and/or an inorganic filler.

5. The resin molding for use as optical base according to claim 1, wherein the resin molding contains a melt tension modifier.

6. The resin molding for use as optical base according to claim 1, wherein the molding is an optical box for a laser beam printer, an optical box for a multifunctional printer, a laser scanner unit, an optical pickup base, an optical pickup lens holder, a chassis for an optical pickup, a chassis for an ink jet, a printer head, a panel frame for a flat display, a collimator holder for a laser beam printer, a liquid crystal display frame, or a lens holder for a liquid crystal projector.
